(19) United States
(12) Patent Application Publication
(10) Pub. No.: US 2026/0106850 A1
(43) Pub. Date: Apr. 16, 2026

(54) CONVERTING DOCUMENTS IN TRANSIT

(71) Applicant: FACTIFY TECHNOLOGIES INC., Dover, DE (US)

(72) Inventors: Matan Gavish, Givat Ada (IL); Gil Asher, Binyamina (IL)

(21) Appl. No.: 19/418,693

(22) Filed: Dec. 12, 2025

Related U.S. Application Data
(63) Continuation of application No. PCT/US2025/034150, filed on Jun. 18, 2025.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/902,847, filed on Oct. 21, 2025.
(60) Provisional application No. 63/902,988, filed on Oct. 21, 2025.
(60) Provisional application No. 63/904,212, filed on Oct. 23, 2025.
(60) Provisional application No. 63/904,235, filed on Oct. 23, 2025.
(60) Provisional application No. 63/905,018, filed on Oct. 24, 2025.
(60) Provisional application No. 63/904,964, filed on Oct. 24, 2025.
(60) Provisional application No. 63/925,068, filed on Nov. 25, 2025.

(51) Int. Cl. H04L 51/08; H04L 51/063; H04L 51/21

(52) U.S. Cl. CPC H04L 51/08; H04L 51/063; H04L 51/21

(57) ABSTRACT

A device may detect an attempt to transmit an electronic document. A device may determine that a policy indicates that the electronic document is to be at least partially converted into a self-determinative document. A device may respond to the determination by provisioning, to the self-determinative document, embedded intelligence that enables self-determination of the document.

### PRIORITY CLAIMS TO RELATED APPLICATIONS

This application is a continuation application of International Patent Application No. PCT/US2025/034150 filed Jun. 18, 2025, which claims priority to U.S. Provisional Patent Application No. 63/925,068 filed Nov. 25, 2025, U.S. Provisional Patent Application No. 63/905,018 filed Oct. 24, 2025, U.S. Provisional Patent Application No. 63/904,964 filed Oct. 24, 2025, U.S. Provisional Patent Application No. 63/904,212 filed Oct. 23, 2025, U.S. Provisional Patent Application No. 63/904,235 filed Oct. 23, 2025, U.S. Provisional Patent Application No. 63/902,847 filed Oct. 21, 2025, U.S. Provisional Patent Application No. 63/902,988 filed Oct. 21, 2025, U.S. Provisional Patent Application No. 63/661,534 filed Jun. 18, 2024, U.S. Provisional Patent Application 63/668,068 filed Jul. 5, 2024, U.S. Provisional Patent Application 63/674,793 filed Jul. 23, 2024, U.S. Provisional Patent Application 63/680,061 filed Aug. 6, 2024, U.S. Provisional Patent Application 63/685,234 filed Aug. 20, 2024, U.S. Provisional Patent Application 63/693,173 filed Sep. 10, 2024, U.S. Provisional Patent Application 63/707,992, filed Oct. 16, 2024, U.S. Provisional Patent Application 63,713,200, filed Oct. 29, 2024, U.S. Provisional Patent Application 63/714,009 filed Oct. 30, 2024, U.S. Provisional Patent Application 63/723,471 filed Nov. 21, 2024, U.S. Provisional Patent Application 63/736,568, filed Dec. 19, 2024, U.S. Provisional Patent Application 63/738,639, filed Dec. 24, 2024, U.S. Provisional Patent Application 63/774,949, filed Mar. 20, 2025, U.S. Provisional Patent Application 63/794,007, filed Apr. 24, 2025, U.S. Provisional Patent Application 63/794,564, filed Apr. 25, 2025, and U.S. Provisional Patent Application 63/800,869, filed May, 6, 2025, and U.S. Provisional Patent Application 63/822,629, filed Jun. 12, 2025, which are each incorporated herein in their entirety by these references which are each incorporated herein in their entirety by these references.

### BACKGROUND

In the modern digital landscape, electronic documents serve as the primary medium for storing, sharing, and transmitting information across various platforms. These documents, often in formats such as PDF, Word, or Excel, are widely used in business, legal, governmental, and personal contexts. However, once an electronic document is transmitted, the sender typically loses control over how the document is accessed, shared, or modified. This lack of control can lead to unauthorized dissemination, security breaches, and the exposure of sensitive information.

Traditional document management systems rely on static security measures, such as encryption, passwords, or access control lists, to protect electronic documents. While these measures provide some level of security, they are inherently limited. For example, once a document is shared via email or uploaded to a cloud storage platform, the sender has no way to dynamically manage or revoke access, track interactions, or enforce compliance with policies. Furthermore, these systems lack the ability to adapt to changing contexts, such as varying user roles, security clearances, or legal requirements.

The proliferation of electronic documents across diverse devices and platforms exacerbates these challenges. Organizations often rely on external tools, such as email, e-signature platforms, or cloud-based collaboration systems, to manage document workflows. These tools, while useful, create fragmented copies of documents, making it difficult to ensure consistency, security, and compliance. Additionally, static document formats, such as PDFs, do not support dynamic, personalized experiences or intelligent features that can adapt to user-specific needs or policies.

There is a growing need for a solution that enables electronic documents to retain control, security, and intelligence throughout their lifecycle, especially as those documents are transmitted and copied from one place to another.

### SUMMARY

In some aspects, the techniques described herein relate to a method including: detecting an attempt to transmit an electronic document; determining that a policy indicates that the electronic document is to be at least partially converted into a self-determinative document; and responding to the determination by provisioning, to the self-determinative document, embedded intelligence that enables self-determination of the document.

In some aspects, the techniques described herein relate to a system including: at least one physical processor; physical memory including computer-executable instructions that, when executed by the physical processor, cause the physical processor to: detect an attempt to transmit an electronic document; determine that a policy indicates that the electronic document is to be at least partially converted into a self-determinative document; and respond to the determination by provisioning, to the self-determinative document, embedded intelligence that enables self-determination of the document.

In some aspects, the techniques described herein relate to a non-transitory computer-readable medium including computer-executable instructions that, when executed by at least one of one or more processors of a computing device, cause the computing device to: detect an attempt to transmit an electronic document; determine that a policy indicates that the electronic document is to be at least partially converted into a self-determinative document; and respond to the determination by provisioning, to the self-determinative document, embedded intelligence that enables self-determination of the document.

These and other features will be more clearly understood from the following detailed description taken in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 depicts a system architecture comprising detection instructions, determination instructions, response instructions, and an access interface, all executed by a physical processor to manage data stored within the system.

FIG. 2 illustrates a networked environment where a server hosts the document, enabling secure communication with computing devices via a network, and includes components such as a viewer for user interaction.

FIG. 3 provides a flowchart of the method for detecting an attempt to transmit an electronic document, determining applicable policies for conversion, and provisioning embedded intelligence to enable self-determination of the document.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The invention of the printing press by Johannes Gutenberg revolutionized information dissemination, establishing a paradigm where documents were static, immutable, and tangible. This approach persisted into the digital age, where electronic documents, despite their digital nature, have largely been treated as “digital bricks”—static entities incapable of adapting or interacting dynamically with their environment. While this model has served its purpose, it is increasingly inadequate in a world that demands rapid information flow, heightened security, and personalized experiences. The concept of converting documents in transit into self-determinative entities marks a transformative shift, enabling electronic documents to evolve into intelligent, adaptive objects that autonomously manage their lifecycle and interactions.

Static electronic documents, such as PDFs or Word files, are inherently limited in their ability to adapt to changing contexts or enforce security and compliance policies. Once transmitted, the sender loses control over the document, exposing it to risks like unauthorized dissemination and security breaches. This fragmented approach often requires multiple versions of the same document or reliance on external systems to enforce access controls, creating inefficiencies and errors. By contrast, self-determinative documents embed intelligence during transmission, allowing them to autonomously enforce policies, adapt to user-specific needs, and retain control throughout their lifecycle. For instance, a document shared with a subscriber may display full content, while the same document shared with a non-subscriber may only display a summary, eliminating the need for redundant versions and ensuring compliance.

The transformation of electronic documents into self-determinative entities offers profound benefits. These intelligent documents enhance security by tracking interactions, enforcing access controls, and preventing unauthorized dissemination. They streamline workflows by eliminating fragmented copies and manual interventions, enabling seamless processes. Moreover, they provide personalized experiences tailored to user roles and preferences, fostering engagement and usability. Positioned as active participants in digital ecosystems, self-determinative documents integrate with emerging technologies like artificial intelligence and blockchain, unlocking their full potential. This paradigm shift is not merely an incremental improvement but a fundamental rethinking of electronic documents, empowering organizations to achieve security, compliance, and efficiency in dynamic digital environments.

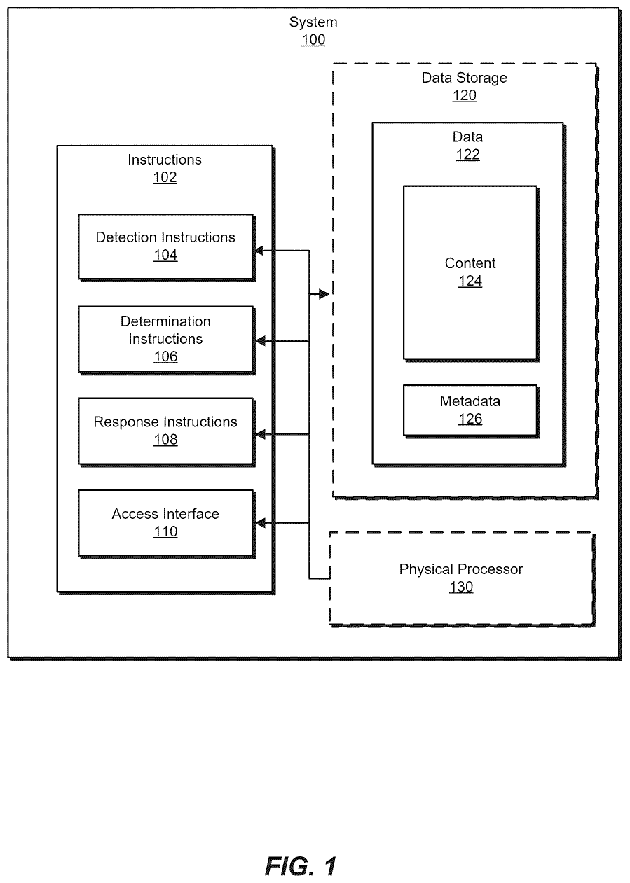

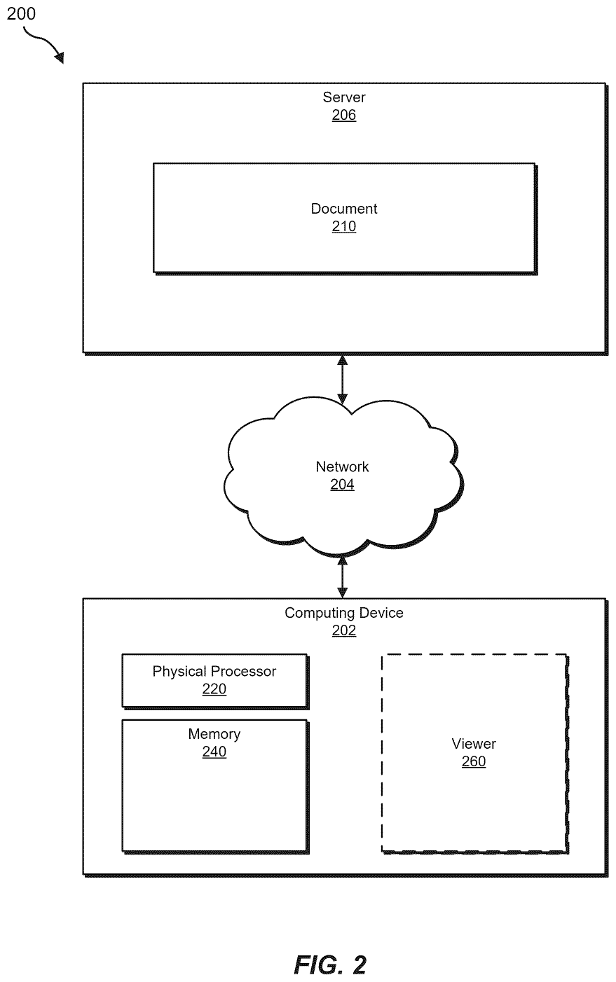

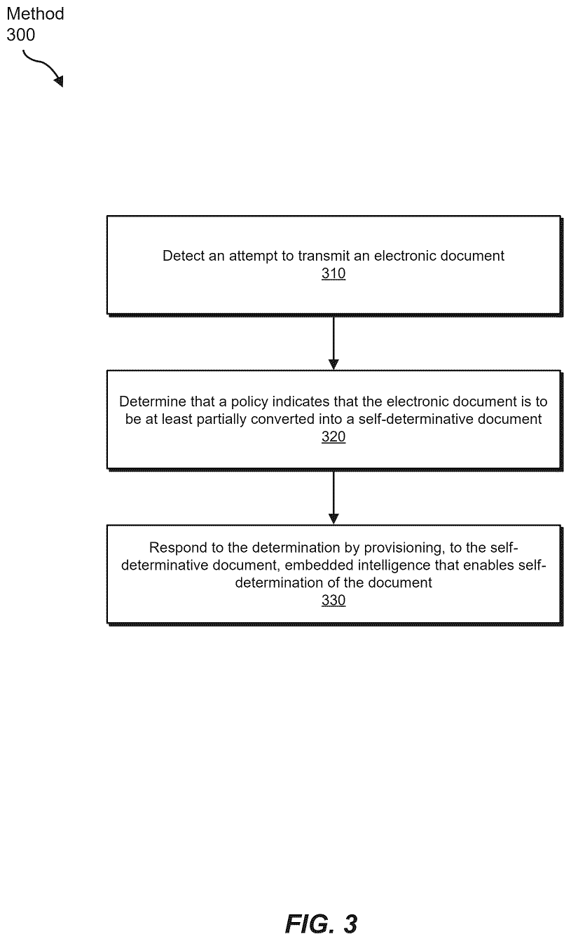

FIGS. 1-3 illustrate exemplary embodiments of the systems and methods for converting electronic documents in transit into self-determinative entities. FIG. 1 depicts a system architecture comprising detection instructions, determination instructions, response instructions, and an access interface, all executed by a physical processor to manage data stored within the system. FIG. 2 illustrates a networked environment where a server hosts the document, enabling secure communication with computing devices via a network, and includes components such as a viewer for user interaction. FIG. 3 provides a flowchart of the method for detecting an attempt to transmit an electronic document, determining applicable policies for conversion, and provisioning embedded intelligence to enable self-determination of the document. Together, these figures demonstrate the technical framework and operational processes that transform static electronic documents into intelligent, adaptive entities capable of autonomous lifecycle management and dynamic interaction.

FIG. 1 illustrates a system 100 for converting electronic documents in transit into entities capable of autonomous decision-making. The system 100 includes instructions 102, data storage 120, data 122, and a physical processor 130. The instructions 102 comprise detection instructions 104, determination instructions 106, response instructions 108, and an access interface 110. These components interact to enable the detection of document transmission attempts, identification of applicable policies, and provisioning of embedded intelligence to create documents with self-governing capabilities.

The detection instructions 104 are configured to identify attempts to transmit electronic documents. These attempts may include actions such as emailing a document or uploading the document to cloud storage. The detection instructions 104 monitor these activities and initiate the process of converting the document into an entity capable of autonomous decision-making.

The determination instructions 106 analyze the detected transmission attempts to identify applicable policies for the electronic document. This analysis may involve evaluating the file type, user roles, or contextual requirements to assess whether the document is to be converted into an entity capable of self-governance. The determination instructions 106 ensure that the conversion process aligns with organizational policies and security protocols.

The response instructions 108 execute the conversion of the electronic document into an entity capable of self-governance. This involves provisioning the document with embedded intelligence that enables autonomous lifecycle management and dynamic interaction. The response instructions 108 may also replace the original document with a link to the self-governing entity, ensuring secure and controlled transmission.

The access interface 110 facilitates interaction between users and the system 100. This interface provides mechanisms for accessing, managing, and interacting with documents that allow users to make autonomous decisions. The access interface 110 may include features such as user authentication, policy enforcement, and document tracking to ensure secure and personalized experiences.

The data storage 120 stores data 122, which may include electronic documents, metadata, and policies relevant to the conversion process. The data storage 120 ensures that the system 100 has access to the necessary information for detecting transmission attempts, determining applicable policies, and provisioning embedded intelligence.

The physical processor 130 executes the instructions 102 to perform the functions of the system 100. The physical processor 130 may include hardware components such as CPUs, microcontrollers, or ASICs capable of interpreting and executing computer-readable instructions. By leveraging the physical processor 130, the system 100 ensures efficient and reliable operation.

In some examples, the data of a self-determinative document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata can include timestamps for when the document was created, edited, shared, or signed. It can also log the identities of users who accessed the document, the nature of their interactions (e.g., viewing, commenting, or editing), and any changes made to the document's content or metadata.

Semantic metadata describes the intrinsic characteristics of a document, answering the question of “what the document is” rather than “what the document contains.” This type of metadata includes information about the document's type, ownership, and categorical classification. For example, semantic metadata can indicate that a document is an NDA (Non-Disclosure Agreement), a marketing presentation, or a financial report. It may also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

FIG. 2 illustrates a networked environment 200 for managing electronic documents during transmission and enabling their conversion into entities capable of autonomous decision-making. The environment 200 includes a server 206, a document 210, a network 204, and a computing device 202, which comprises a physical processor 220, memory 240, and a viewer 260.

The server 206 is configured to host the document 210 and facilitate secure transmission and management of the document. The document 210 may represent an electronic file, such as a PDF, Word document, or other formats, that is designed to function as an autonomous entity. The server 206 interacts with other components of the environment 200 to ensure the document 210 is processed in compliance with applicable policies.

The network 204 provides the communication medium between the server 206 and the computing device 202. The network 204 may include various types of communication channels, such as wired or wireless connections, and may operate over protocols like TCP/IP to enable secure and efficient data exchange.

The computing device 202 is equipped with a physical processor 220 and memory 240, which together execute instructions for interacting with the document 210 and performing the conversion of the document into an autonomous entity. The physical processor 220 processes data and executes operations related to document management, while the memory 240 stores relevant data, instructions, and policies required for the conversion process. The viewer 260 is a component of the computing device 202 that facilitates user interaction with the document 210. The viewer 260 may provide functionalities such as displaying the document, tracking user interactions, and enforcing access controls. The viewer 260 ensures that the document 210 is presented in a manner consistent with the document's autonomous capabilities, allowing users to interact with the document securely and dynamically.

An electronic document with embedded computer-executable code, which is also referred to herein as a smart electronic document, generally refers to a type of electronic document embedded with intelligence that enables it to autonomously monitor, record, and manage events associated with its lifecycle, access, and interactions. Unlike traditional documents, which depend on external systems or manual input to track changes and interactions, smart electronic documents are designed to independently identify and log activities such as access attempts, modifications, and interactions with other documents or systems.

The embedded intelligence within a smart electronic document allows it to maintain a detailed audit trail, offering insights into who accessed the document, when it was accessed, and what actions were performed. This capability is invaluable for ensuring compliance with regulatory requirements and organizational policies, as it provides a reliable and tamper-proof record of all document-related activities.

Smart electronic documents also enhance security by dynamically managing access permissions through mechanisms such as role-based access control, encryption, and multi-factor authentication. These documents ensure that only authorized users can view or modify their content. By transforming documents into active entities capable of self-monitoring and self-regulation, organizations can significantly reduce the risk of unauthorized access and data breaches while streamlining document management processes and maintaining data integrity. A smart electronic document is composed of code (i.e., intelligence), content, and metadata, which together enable its autonomous functionalities.

The attributes of a smart electronic document are multifaceted and address one or more of the limitations of traditional document management systems. For example, a smart electronic document is uniquely addressable, meaning it has a permanent and immutable identifier that distinguishes it from all other documents. This identifier ensures that the document can be reliably accessed and referenced, regardless of its location. Additionally, the document is equipped with machine-readable metadata that captures detailed information about its interactions, such as timestamps, user credentials, geolocation data, and the nature of the interaction. This metadata is not only comprehensive but also structured in a way that supports automated processing and analysis, enabling advanced functionalities such as real-time auditing and compliance verification.

Another attribute of a smart electronic document is its ability to maintain version control. When changes need to be made to the document, a new uniquely addressable version is created, rather than altering the original document. This approach preserves the integrity of the original document while providing a clear record of its evolution. Each version is assigned its own unique identifier, ensuring that it can be independently accessed and verified. The relationship between versions is also recorded, creating a hierarchical structure that allows users to trace the document's history and understand the context of each modification. For example, if a contract is updated to include new terms, the updated version will reference the original version, enabling auditors to compare the two and verify the changes.

The creation of new versions is governed by strict rules and cryptographic mechanisms to ensure authenticity and prevent unauthorized modifications. When a user or system initiates a change, the smart electronic document generates a cryptographic signature that validates the modification and ties it to the new version. This signature is stored as part of the document's metadata, providing a tamper-proof record of the change. Additionally, the document's embedded intelligence ensures that all changes are logged in its audit trail, capturing details such as who made the change, when it was made, and why it was made. This level of detail not only supports transparency but also enhances security by making it virtually impossible to alter the document without leaving a trace.

In some examples, the immutability of the content in a smart electronic document is a foundational characteristic that ensures the integrity, reliability, and trustworthiness of the document throughout its lifecycle. This immutability is achieved through a combination of technical mechanisms and design principles, which are explained below.

The “content” of a smart electronic document refers to the core information that constitutes the document, such as text, images, tables, or other embedded elements. This content is distinct from metadata (which provides supplementary information about the document, such as timestamps, user interactions, and version history) and executable code (which enables the document's intelligent functionalities). The immutability applies specifically to the content, ensuring that it remains unchanged once the document is finalized or authenticated.

To ensure immutability, the content of a smart electronic document can be cryptographically hashed at the time of its creation or finalization. A cryptographic hash is a unique, fixed-length string generated from the content using a hashing algorithm (e.g., SHA-256). This hash acts as a digital fingerprint of the content. If even a single character or pixel in the content is altered, the hash will change, making it immediately evident that the content has been tampered with.

Any system or user accessing the document can verify its integrity by recalculating the hash and comparing it to the original hash stored in the document's metadata. If the hashes match, the content is confirmed to be unchanged.

In cases where changes to the document are necessary (e.g., updates or amendments), the smart electronic document does not alter the original content. Instead, it creates a new version of the document with its own unique identifier and cryptographic hash. The original version remains intact and accessible, ensuring that the history of the document is preserved. Each version of the document is uniquely addressable and linked to the previous versions, creating a hierarchical structure that allows users to trace the evolution of the document. This approach ensures that the original content is never overwritten or lost.

In some embodiments, the smart electronic document may leverage distributed ledger technology to ensure immutability. The content and its associated hash can be recorded on a distributed ledger, where each entry is cryptographically secured and immutable. This approach provides an additional layer of protection, as the distributed ledger ensures that the content cannot be altered without consensus from the network.

The smart electronic document separates its content from other mutable elements, such as metadata and executable code. While metadata and code can be updated to reflect new interactions or functionalities, the content layer remains fixed and unchangeable. This separation ensures that the core information of the document is preserved, even as the document evolves in other ways.

The smart electronic document can provides transparency to users by enabling them to verify the authenticity and integrity of the content at any time. This transparency is achieved through audit trails and visual indicators, ensuring that users can trust the document's reliability and security.

FIG. 3 illustrates a flowchart of an exemplary method 300 for converting electronic documents in transit into self-determinative entities. The method begins with detecting an attempt to transmit an electronic document, such as through email or cloud storage upload, as shown in step 310. Next, step 320 involves determining whether a policy indicates that the electronic document should be at least partially converted into a self-determinative document, based on factors such as file type, user roles, or contextual requirements. Finally, step 330 demonstrates responding to the determination by provisioning embedded intelligence to the self-determinative document, enabling it to autonomously manage its lifecycle, enforce access controls, and adapt to contextual requirements. This flowchart provides a visual representation of the transformative process that ensures electronic documents retain control, security, and adaptability throughout their lifecycle.

Step 310 of FIG. 3 involves detecting an attempt to transmit an electronic document, which serves as the initial trigger for the process of converting the document into a self-determinative entity. This detection can occur in various contexts and through multiple mechanisms, depending on the transmission method and the system's configuration. For example, the system may monitor outgoing emails to identify when an electronic document, such as a PDF or Word file, is attached to an email and prepared for sending. Similarly, the system can detect attempts to upload a document to cloud storage platforms, such as Google Drive, Dropbox, or Microsoft OneDrive, by intercepting file transfer requests. In another scenario, the system may identify attempts to share a document via collaboration tools like Slack, Microsoft Teams, or Zoom, where files are often exchanged during meetings or discussions. Detection can also extend to physical actions, such as printing a document or copying it to an external storage device like a USB drive. For instance, if a user attempts to print a sensitive document, the system can intercept the print command and initiate the conversion process before the document is physically rendered. Similarly, when a document is copied to a removable storage device, the system can detect the file transfer and apply the necessary policies to ensure the document retains its self-determinative capabilities.

The detection mechanism may rely on various technologies, including file system monitoring, network traffic analysis, or integration with document management systems. For example, the system can use hooks into the operating system to monitor file operations, such as “save as” or “export” commands, to identify when a document is being prepared for transmission. Alternatively, the system can analyze network traffic to detect file uploads or downloads, leveraging deep packet inspection to identify document-related activities. Integration with document management systems, such as SharePoint or DocuSign, can provide additional layers of detection by monitoring workflows and user actions within these platforms.

In some embodiments, the detection process may be proactive, using machine learning models to predict potential transmission attempts based on user behavior. For instance, if a user frequently shares documents with external collaborators, the system may flag certain files as likely candidates for transmission and preemptively apply policies to those files. Additionally, the system can use contextual cues, such as the presence of sensitive keywords or metadata within the document, to prioritize detection efforts. For example, a document containing terms like “confidential,” “trade secret,” or “NDA” may be flagged for immediate conversion into a self-determinative entity upon detection of a transmission attempt.

The detection process can also be customized based on organizational policies and user roles. For instance, a company may configure the system to monitor all outgoing documents from employees in the legal or finance departments, where sensitive information is more likely to be transmitted. Alternatively, the system can be set to detect transmission attempts only for documents marked with specific tags or classifications, such as “restricted” or “internal use only.”

In summary, step 310 encompasses a detection mechanism that identifies attempts to transmit electronic documents across various channels and contexts. By leveraging technologies such as file system monitoring, network traffic analysis, machine learning, and integration with document management systems, the system ensures that no transmission attempt goes unnoticed, enabling the subsequent steps of the conversion process to be applied effectively.

Step 320 of FIG. 3 involves determining whether a policy indicates that the electronic document should be at least partially converted into a self-determinative document. This step is critical for ensuring that the conversion process aligns with organizational policies, security protocols, and contextual requirements. The determination process begins by analyzing the characteristics of the document and the circumstances surrounding its transmission. For example, the system may evaluate the file type, such as PDF, Word, or Excel, to determine whether the document falls within a category that requires conversion. Certain file types, such as contracts, financial reports, or legal documents, may be preconfigured to trigger conversion due to their sensitive nature.

In addition to file type, the system may assess metadata associated with the document, such as tags, classifications, or embedded properties. For instance, a document marked as “confidential” or “restricted” in its metadata may automatically qualify for conversion. Similarly, documents containing specific keywords, such as “trade secret,” “NDA,” or “proprietary,” may be flagged for conversion based on predefined keyword policies. The system can also analyze the document's content using natural language processing (NLP) techniques to identify sensitive information, such as personally identifiable information (PII), financial data, or intellectual property, which may necessitate conversion.

The determination process also considers the identity and role of the sender and recipient. For example, if the sender is a member of the legal or finance department, the system may apply stricter policies to their outgoing documents. Similarly, the recipient's role or security clearance may influence the determination. For instance, a document sent to a subscriber may require conversion to ensure that only authorized content is accessible, while a document sent to a non-subscriber may be converted to display only a summary or redacted version. In another example, a document shared with a board member may include sensitive financial details, while the same document shared with a general employee may exclude those details.

Contextual factors, such as the transmission method and destination, also play a role in the determination process. For instance, a document uploaded to a public cloud storage platform may require conversion to ensure that access controls are enforced, while a document shared within a secure internal network may not require conversion. Similarly, documents transmitted via email may be subject to stricter policies than those shared through encrypted collaboration tools. The system can also consider the geographic location of the recipient, applying region-specific policies to comply with local regulations, such as GDPR or HIPAA.

In some embodiments, the determination process may involve machine learning models trained to evaluate transmission attempts and predict whether conversion is necessary. These models can analyze historical data, user behavior, and contextual cues to make informed decisions. For example, if a user frequently shares sensitive documents with external collaborators, the system may automatically flag their outgoing documents for conversion. Additionally, the system can use predictive analytics to identify potential risks associated with the transmission, such as the likelihood of unauthorized access or data leakage, and apply conversion policies accordingly.

The determination process can also be customized based on organizational policies and user preferences. For instance, a company may configure the system to apply conversion policies only to documents shared externally, while allowing internal documents to remain unconverted. Alternatively, the system can be set to apply conversion policies selectively, based on the document's classification or the recipient's role. In some cases, the sender may be given the option to override the system's determination, allowing them to manually decide whether conversion is necessary.

In summary, step 320 involves a comprehensive and flexible determination process that evaluates the document's characteristics, metadata, content, sender and recipient roles, transmission method, and contextual factors to decide whether conversion into a self-determinative entity is required. By leveraging technologies such as NLP, machine learning, and predictive analytics, the system ensures that conversion policies are applied effectively and in alignment with organizational goals and security requirements.

Step 330 of FIG. 3 involves responding to the determination by provisioning embedded intelligence to the electronic document, thereby converting it into a self-determinative entity. This step is the culmination of the process, where the document is transformed from a static file into an intelligent, adaptive entity capable of autonomously managing its lifecycle, enforcing access controls, and adapting to contextual requirements. The provisioning process may vary depending on the document's characteristics, the applicable policies, and the intended use case.

In one example, if the determination in step 320 indicates that the document should be converted, the system may embed intelligence into the document by associating it with a unique identifier and linking it to a secure cloud-based repository. This repository serves as the central location for managing the document's lifecycle, ensuring that all interactions with the document are tracked and controlled. The embedded intelligence may include features such as access control mechanisms, interaction tracking, and dynamic content rendering. For instance, a document shared under a non-disclosure agreement (NDA) may be provisioned to automatically revoke access once the NDA expires, ensuring compliance without manual intervention.

In another example, the system may replace the original document with a link to the self-determinative entity. This approach ensures that the document remains secure and centralized, while recipients interact with the document through the link. The link may direct users to a secure viewer that enforces access controls and provides personalized experiences based on the user's role or security clearance. For instance, a contract shared with a board member may display sensitive financial details, while the same contract shared with a general employee may display only general terms. This dynamic adaptation eliminates the need for multiple versions of the document and ensures compliance with organizational policies.

If the determination indicates that a different instance of the document has already been converted into a self-determinative entity, the system may simply replace the electronic document being transmitted with a link to the existing self-determinative entity. This ensures consistency and avoids duplication, while maintaining centralized control over the document. Alternatively, if no instance of the document has been previously converted, the system may create a new self-determinative entity by embedding intelligence into the document's content and linking it to a secure repository. This process may involve encrypting the document, associating it with metadata, and provisioning it with rules for access, modification, and tracking.

The embedded intelligence may also include features for tracking user interactions, such as viewing, editing, or sharing the document. For example, the system may generate receipts for each interaction, providing the document owner with a detailed log of activities. This level of transparency enhances security and accountability, ensuring that the document is handled appropriately throughout its lifecycle. Additionally, the embedded intelligence may enable the document to adapt to changing contexts, such as varying user roles or security requirements. For instance, a document shared with a subscriber may display the full content, while the same document shared with a non-subscriber may display only a summary.

In some embodiments, the provisioning process may involve integrating the document with external systems, such as artificial intelligence (AI) platforms or blockchain networks. For example, the document may be provisioned to interact with an AI model that analyzes user behavior and provides recommendations for improving document security or usability. Alternatively, the document may be linked to a blockchain ledger to ensure immutability and traceability, providing an additional layer of security and trust.

The provisioning process can also be customized based on organizational policies and user preferences. For instance, a company may configure the system to provision embedded intelligence only for documents shared externally, while allowing internal documents to remain unconverted. Alternatively, the system can be set to provision intelligence selectively, based on the document's classification or the recipient's role. In some cases, the sender may be given the option to override the system's provisioning process, allowing them to manually decide how the document should be converted.

In summary, step 330 involves a robust and flexible provisioning process that transforms electronic documents into self-determinative entities by embedding intelligence and linking them to secure repositories. By leveraging features such as access controls, interaction tracking, dynamic content rendering, and integration with external systems, the system ensures that documents retain control, security, and adaptability throughout their lifecycle. This step is essential for enabling the modern paradigm of intelligent, adaptive electronic documents that can autonomously manage their interactions and compliance requirements.

In one example, the method involves detecting an attempt to transmit an electronic document via email. When a user attaches a document, such as a PDF or Word file, to an email and prepares to send it, the system identifies this action as a transmission attempt. Instead of allowing the original document to be sent, the system intervenes and replaces the attached document with a link or entry page to a self-determinative version of the document. This self-determinative version is stored in a secure repository, such as a cloud-based location, where it can be managed and controlled by the sender or document owner. The link embedded in the email directs the recipient to the secure repository, enabling them to access the document under predefined conditions.

For example, if the sender is sharing a contract with a business partner, the self-determinative document may enforce access controls based on the recipient's role or security clearance. A board member may see sensitive financial details, while a general employee may only see high-level terms. The link ensures that the document remains centralized and secure, preventing unauthorized dissemination or modification. Once the link replaces the original document, the email is allowed to proceed to its destination without disruption to the sender's workflow.

This approach offers several advantages. First, it eliminates the risk of creating multiple uncontrolled copies of the document, as the original file is never directly transmitted. Second, it allows the sender to retain control over the document even after it has been shared. For instance, the sender can revoke access to the document at any time or track interactions, such as views or edits, through the embedded intelligence in the self-determinative document. Third, it ensures compliance with organizational policies, as the document can dynamically adapt to security requirements or legal obligations.

In alternative scenarios, the system may provide additional functionalities. For instance, the link can direct the recipient to a viewer that enforces authentication before granting access to the document. This ensures that only authorized users can interact with the document. The system may also allow the sender to customize the recipient's experience, such as enabling annotations or restricting downloads. In another variation, the system can integrate with email platforms to provide real-time notifications to the sender when the recipient accesses the document, enhancing transparency and accountability.

Furthermore, the system can be configured to handle different types of transmission attempts. For example, if the sender attempts to forward an email containing the link, the system can ensure that the forwarded link retains the same access controls and policies as the original. Alternatively, if the sender attempts to send the document to multiple recipients, the system can generate individualized links for each recipient, allowing for personalized access experiences based on their roles or permissions.

In summary, this method transforms the process of emailing documents by replacing the original file with a secure link or entry page to a self-determinative version. This ensures centralized control, enhanced security, and dynamic adaptability, while maintaining the sender's ability to share information seamlessly. By leveraging embedded intelligence and secure repositories, the system addresses the challenges of traditional document sharing and provides a robust solution for modern workflows.

In one example, the method involves detecting an attempt to upload an electronic document to a cloud storage platform. When a user initiates the upload process, such as transferring a file to services like Google Drive, Dropbox, or Microsoft OneDrive, the system identifies this action as a transmission attempt. Instead of allowing the original document to be uploaded in its static form, the system intervenes and converts the document into a self-determinative entity. This conversion process involves embedding intelligence into the document, enabling it to autonomously manage its lifecycle, enforce access controls, and adapt to contextual requirements. Once converted, the document is stored in the cloud as a self-determinative entity, ensuring that it retains control and security even after being uploaded.

For example, if the document being uploaded is a financial report, the system may enforce policies that restrict access to certain sections based on the roles of users accessing the cloud storage. A manager may be able to view detailed financial data, while a general employee may only see summary-level information. Similarly, if the document is a contract, it may dynamically adapt its content based on the recipient's subscription status or security clearance. This ensures that sensitive information is protected and that the document complies with organizational policies.

The system may also replace the original document with a link or coverpage to the self-determinative version stored in the cloud. This link ensures that the document remains centralized and secure, while users interact with the document through the cloud interface. For instance, when a user attempts to access the document from the cloud storage platform, the system can enforce authentication protocols, track interactions, and provide personalized experiences based on the user's role or permissions. This approach eliminates the risk of creating uncontrolled copies of the document and ensures that the document's lifecycle is managed effectively.

In alternative scenarios, the system may provide additional functionalities. For example, the self-determinative document may include features for tracking user interactions, such as viewing, editing, or sharing the document. The system may generate detailed logs of these interactions, providing the document owner with insights into how the document is being used. Additionally, the system may allow the document to adapt to changing contexts, such as varying user roles or security requirements. For instance, a document uploaded to a shared cloud folder may display different content to different users based on their access privileges.

The system can also be configured to handle different types of cloud storage platforms and transmission methods. For example, if the user attempts to upload the document to a public cloud storage platform, the system may enforce stricter security measures, such as encryption or multi-factor authentication. Alternatively, if the document is uploaded to a private cloud or an enterprise storage system, the system may apply policies tailored to the organization's specific requirements. In another variation, the system may integrate with cloud storage APIs to provide real-time notifications to the document owner when the document is accessed or modified.

Furthermore, the system may allow the document owner to customize the document's behavior within the cloud storage environment. For instance, the owner may set expiration dates for access, restrict downloads, or enable collaborative features such as annotations or comments. The system may also provide options for integrating the self-determinative document with other cloud-based tools, such as project management platforms or data analytics systems, enhancing its utility and adaptability.

In summary, this method transforms the process of uploading documents to cloud storage by converting them into self-determinative entities. This ensures centralized control, enhanced security, and dynamic adaptability, while maintaining the user's ability to store and share information seamlessly. By leveraging embedded intelligence and cloud-based repositories, the system addresses the challenges of traditional document storage and provides a robust solution for modern workflows.

In one example, the method involves determining whether an electronic document should be at least partially converted into a self-determinative entity by analyzing its file type. The system begins by identifying the file type of the document, such as PDF, Word, Excel, or other formats, as part of the evaluation process. Certain file types may be preconfigured to trigger conversion based on their inherent characteristics or the context in which they are used. For instance, PDFs are often associated with finalized, legally binding, or immutable documents, making them ideal candidates for conversion into self-determinative entities. Similarly, Word documents may be flagged for conversion when they contain sensitive information, such as contracts, proposals, or internal reports.

The determination process may involve predefined policies that specify which file types are subject to conversion. For example, an organization may configure the system to automatically convert all PDFs shared externally, as these documents are frequently used in legal, financial, or compliance-related contexts. Alternatively, the system may apply conversion policies selectively, targeting specific file types based on their metadata, content, or usage patterns. For instance, Excel spreadsheets containing financial data may be flagged for conversion to ensure that access to sensitive information, such as revenue projections or budget allocations, is tightly controlled.

In addition to predefined policies, the system may use contextual analysis to determine whether a file type should be converted. For example, if a Word document is shared with external collaborators, the system may evaluate its content and metadata to identify sensitive keywords, such as “confidential,” “trade secret,” or “NDA.” If such keywords are detected, the system may determine that the document should be converted into a self-determinative entity to enforce access controls and compliance requirements. Similarly, the system may analyze the document's metadata to identify classifications or tags, such as “restricted” or “internal use only,” which may indicate that the file type is subject to conversion.

The system may also leverage machine learning models to enhance the determination process. These models can analyze historical data and user behavior to predict which file types are likely to require conversion. For instance, if a user frequently shares Excel spreadsheets containing sensitive financial data, the system may automatically flag similar files for conversion in the future. Additionally, the system can use predictive analytics to assess the risk associated with sharing specific file types, such as the likelihood of unauthorized access or data leakage, and apply conversion policies accordingly.

In some scenarios, the system may allow for manual overrides or user input to refine the determination process. For example, a sender may be prompted to confirm whether a particular file type should be converted before transmission. This approach provides flexibility and ensures that the system aligns with the sender's intent and organizational policies. Alternatively, the system may provide recommendations based on its analysis, allowing the sender to make informed decisions about whether to convert the document.

The determination process can also be tailored to specific organizational needs or industry requirements. For instance, a healthcare organization may configure the system to convert all files containing patient data, regardless of file type, to comply with regulations such as HIPAA. Similarly, a financial institution may prioritize the conversion of spreadsheets and PDFs containing sensitive financial information to ensure compliance with internal policies and external regulations.

In summary, this method evaluates the file type of an electronic document to determine whether it should be converted into a self-determinative entity. By leveraging predefined policies, contextual analysis, machine learning, and user input, the system ensures that file types associated with sensitive or critical information are appropriately converted. This approach enhances security, compliance, and control, while providing flexibility to adapt to diverse organizational and industry-specific requirements.

In one example, the method involves responding to the determination by identifying that a different instance of the electronic document has already been converted into a self-determinative entity and replacing the electronic document being transmitted with a link to the existing self-determinative document. This approach ensures consistency, avoids duplication, and maintains centralized control over the document. When the system detects an attempt to transmit an electronic document, it first checks whether a self-determinative version of the document already exists. This may involve searching a secure repository or database where converted documents are stored, using unique identifiers or metadata associated with the document to locate the existing instance.

If the system determines that a self-determinative version of the document is already available, it replaces the original document being transmitted with a link to the existing self-determinative entity. This link directs the recipient to the secure repository where the document is stored, allowing them to access the document under predefined conditions. For example, if the document is a contract, the link may enforce access controls based on the recipient's role or security clearance. A board member may see sensitive financial details, while a general employee may only see general terms. This ensures that the document remains centralized and secure, while providing personalized experiences to recipients based on their access privileges.

This approach eliminates the risk of creating multiple uncontrolled copies of the document, as the original file is never directly transmitted. Instead, all interactions with the document are routed through the self-determinative version stored in the secure repository. This centralized control allows the document owner to track interactions, revoke access, or update the document as needed, ensuring that the document remains secure and compliant with organizational policies.

In alternative scenarios, the system may provide additional functionalities when replacing the document with a link. For instance, the link can direct the recipient to a viewer that enforces authentication before granting access to the document. This ensures that only authorized users can interact with the document. The system may also allow the sender to customize the recipient's experience, such as enabling annotations, restricting downloads, or providing real-time notifications when the recipient accesses the document. These features enhance transparency and accountability while maintaining control over the document.

If the system determines that no self-determinative version of the document exists, it may proceed to create a new self-determinative entity by embedding intelligence into the document's content and linking it to a secure repository. This ensures that the document is converted before transmission, allowing the sender to retain control over the document even after it has been shared. In this case, the original document is replaced with a link to the newly created self-determinative version, ensuring that all interactions with the document are routed through the secure repository.

The system can also be configured to handle different types of transmission attempts. For example, if the sender attempts to forward an email containing the link, the system can ensure that the forwarded link retains the same access controls and policies as the original. Alternatively, if the sender attempts to send the document to multiple recipients, the system can generate individualized links for each recipient, allowing for personalized access experiences based on their roles or permissions.

In summary, this method ensures that electronic documents are managed efficiently and securely by replacing the original file with a link to an existing self-determinative version whenever possible. By leveraging centralized control, personalized access, and secure repositories, the system addresses the challenges of traditional document sharing and provides a robust solution for modern workflows. This approach enhances security, compliance, and usability while eliminating the inefficiencies associated with duplicate document instances.

In one example, the method involves responding to the determination by identifying that no instance of the electronic document has already been converted into a self-determinative entity. Upon making this determination, the system proceeds to create a new self-determinative document by embedding intelligence into the content of the original document. This embedded intelligence transforms the document into an adaptive entity capable of autonomously managing its lifecycle, enforcing access controls, and responding to contextual requirements. Once the self-determinative document is created, the system replaces the original document being transmitted with a link to the newly created self-determinative version, ensuring secure and centralized management of the document.

The process of creating the self-determinative document begins by associating the embedded intelligence with the document's content. This may involve encrypting the document, adding metadata, and provisioning it with rules for access, modification, and tracking. For example, the embedded intelligence may include features such as dynamic content rendering, interaction tracking, and access control mechanisms. A financial report, for instance, may be provisioned to display detailed data to a manager while showing only summary-level information to a general employee. Similarly, a contract may adapt its content based on the recipient's subscription status or security clearance, ensuring compliance with organizational policies.

Once the self-determinative document is created, the system replaces the original document with a link to the secure repository where the self-determinative version is stored. This link ensures that the document remains centralized and secure, while recipients interact with the document through the link. For example, when a recipient clicks on the link, they may be directed to a secure viewer that enforces authentication protocols and provides personalized experiences based on their role or permissions. A board member accessing the document may see sensitive financial details, while a general employee may only see general terms. This dynamic adaptation eliminates the need for multiple versions of the document and ensures compliance with organizational policies.

The system may also provide additional functionalities during the creation and replacement process. For instance, the embedded intelligence may include features for tracking user interactions, such as viewing, editing, or sharing the document. The system may generate detailed logs of these interactions, providing the document owner with insights into how the document is being used. Additionally, the system may allow the document to adapt to changing contexts, such as varying user roles or security requirements. For example, a document shared under a non-disclosure agreement (NDA) may automatically revoke access once the NDA expires, ensuring compliance without manual intervention.

In alternative scenarios, the system may integrate the self-determinative document with external systems, such as artificial intelligence (AI) platforms or blockchain networks. For example, the document may interact with an AI model to analyze user behavior and provide recommendations for improving document security or usability. Alternatively, the document may be linked to a blockchain ledger to ensure immutability and traceability, providing an additional layer of security and trust.

The system can also be configured to handle different types of transmission attempts. For example, if the sender attempts to forward an email containing the link, the system can ensure that the forwarded link retains the same access controls and policies as the original. Alternatively, if the sender attempts to send the document to multiple recipients, the system can generate individualized links for each recipient, allowing for personalized access experiences based on their roles or permissions.

In summary, this method ensures that electronic documents are securely and efficiently managed by creating a new self-determinative version when no prior instance exists. By embedding intelligence into the document's content and replacing the original file with a secure link, the system provides centralized control, dynamic adaptability, and enhanced security. This approach addresses the challenges of traditional document sharing and storage, offering a robust solution for modern workflows while ensuring compliance, usability, and scalability.

In one example, the method involves utilizing a machine-learning model to analyze a self-determinative document and provide actionable recommendations to the document's owner based on the analysis. The machine-learning model is specifically trained to interact with self-determinative documents, leveraging their embedded intelligence and metadata to extract insights and identify patterns. This analysis can encompass a wide range of factors, including user interactions, access history, content sensitivity, compliance requirements, and contextual data related to the document's lifecycle.

For instance, the machine-learning model may analyze the document's access logs to identify unusual activity, such as repeated access attempts from unauthorized users or access from unexpected geographic locations. Based on this analysis, the model can recommend that the owner tighten access controls, revoke certain permissions, or enable multi-factor authentication for specific users. Similarly, the model may detect patterns in user behavior, such as frequent edits or annotations by a particular collaborator, and suggest optimizing the document's workflow by granting that user additional privileges or streamlining their access.

The machine-learning model can also analyze the content of the document itself to identify potential risks or opportunities. For example, if the document contains sensitive financial data, the model may recommend encrypting specific sections or restricting access to users with higher security clearances. Alternatively, if the document is a contract, the model may identify clauses that are frequently negotiated and suggest preemptive adjustments to improve efficiency in future transactions. In another scenario, the model may detect outdated information within the document and recommend updates to ensure accuracy and relevance.

Beyond security and content analysis, the machine-learning model can provide recommendations to enhance compliance with organizational policies or regulatory requirements. For instance, if the document is subject to data protection laws such as GDPR or HIPAA, the model may flag sections that require additional safeguards or suggest anonymizing certain data fields. Similarly, the model may identify opportunities to align the document with internal standards, such as formatting guidelines or approval workflows, and recommend adjustments accordingly.

The recommendations provided by the machine-learning model can also extend to improving the document's usability and engagement. For example, the model may analyze user feedback or interaction patterns to suggest reorganizing the document's structure, adding visual aids, or incorporating interactive elements to enhance readability and accessibility. In collaborative environments, the model may recommend integrating the document with project management tools or communication platforms to facilitate teamwork and streamline processes.

In alternative scenarios, the machine-learning model may leverage external data sources to enrich its analysis and recommendations. For instance, the model can cross-reference the document's content with market trends, industry benchmarks, or competitor data to provide strategic insights. If the document is a marketing proposal, the model may suggest incorporating data-driven elements, such as customer demographics or performance metrics, to strengthen its impact. Similarly, if the document is a research paper, the model may identify relevant citations or emerging topics to enhance its credibility and relevance.

The machine-learning model can also be configured to provide recommendations in real-time, enabling the document owner to make informed decisions as the document evolves. For example, during a live collaboration session, the model may suggest adjustments to permissions or content based on user activity and feedback. Alternatively, the model may provide periodic reports summarizing key insights and actionable steps, allowing the owner to proactively manage the document's lifecycle.

In summary, this method leverages a machine-learning model trained to interact with self-determinative documents to analyze their content, interactions, and context, providing tailored recommendations to the document's owner. By addressing security, compliance, usability, and strategic opportunities, the model enhances the document's value and functionality while ensuring it remains aligned with organizational goals and user needs. This approach offers a dynamic and intelligent solution for managing self-determinative documents in complex and evolving digital environments.

A legacy document refers to a static, traditional file format, such as PDF, Word, JPEG, or other formats, that lacks dynamic, interactive, or intelligent features. These formats are widely used in existing workflows and systems but are inherently limited in their ability to adapt to modern requirements, such as dynamic content rendering, embedded intelligence, or contextual awareness. The concept of an entry page addresses the challenge of replacing these legacy documents with a transitional mechanism that bridges the gap between the static nature of legacy formats and the advanced capabilities of factified documents. The entry page serves as a container within the legacy format, designed to guide users toward accessing the full features of the factified document while maintaining compatibility with legacy systems.

The entry page is a representation of the factified document within the constraints of a legacy format. For example, a PDF entry page can be opened in traditional PDF readers, displaying a static cover page with a message such as, “This document is a factified document. To access its full features, click the embedded link or scan the QR code.” This approach allows the legacy document format to act as a bridge, enabling users to transition seamlessly to the factified document's dynamic experience. Similarly, a static image entry page, represented as a JPEG file, can include visual instructions and a QR code that directs the user to the factified document. This replaces the legacy JPEG file with an entry page that retains compatibility with traditional image viewers while introducing users to the advanced features of factified documents.

The entry page also addresses the challenge of integrating smart electronic documents into legacy workflows, such as email attachments or customer portals. For instance, a legacy document attached to an email can be replaced with an entry page in PDF format that includes instructions for accessing the factified version. This ensures that the document remains compatible with traditional email systems while introducing users to the new paradigm. Similarly, in scenarios where documents are transmitted via fax, the legacy document can be replaced with a printed entry page that includes a QR code or URL, allowing the recipient to access the dynamic version online. This approach ensures that even legacy communication methods can accommodate the transition to factified documents.

The entry page is particularly useful in hybrid scenarios, where the same file can be opened in both legacy and factified document readers. For example, a smart document represented as a PDF entry page can be opened in a traditional PDF reader, displaying the static entry page, or in a factified document reader, providing access to the document's dynamic features. This dual-use capability allows the entry page to act as a bridge for users who have not yet adopted factified document systems while providing full functionality for those who have. The technical implementation of the entry page leverages lightweight mechanisms to ensure compatibility with legacy systems while maintaining a secure connection to the smart document. For example, QR codes embedded in the entry page provide quick access to the factified document, while URLs offer permanent links to the dynamic version. Invisible watermarks and machine-readable codes can be included to enhance tracking and verification, ensuring that the entry page remains linked to the original smart document.

The entry page solves the critical problem of backward compatibility by embedding factified documents within legacy workflows and systems. It allows organizations to transition seamlessly to the new paradigm without disrupting existing processes. By replacing legacy documents with entry pages, users are introduced to the capabilities of factified documents, promoting adoption while ensuring universal compatibility. This approach enhances security by linking legacy representations to the original factified document, reducing the risk of duplication or tampering. It also educates users about the benefits of factified documents, encouraging them to embrace the new paradigm. In summary, the entry page is a transformative innovation that bridges the gap between legacy document systems and the advanced capabilities of factified documents, ensuring backward compatibility while promoting the adoption of dynamic, intelligent document experiences.

When an electronic document is sent to an agency that only handles PDFs, the process of identifying the document upon its return becomes critical. Agencies often operate within legacy systems that are incompatible with advanced document formats, necessitating the conversion of intelligent documents into static formats like PDFs for submission. Once the agency processes the document and returns it, the challenge lies in recognizing the document as the same one that was originally sent. This requires a robust mechanism to match the returned document to its original source, ensuring continuity and preventing duplication. Such a mechanism can involve embedding unique identifiers or codes within the document before it is sent, allowing the system to verify its identity upon return. This process closes the loop, ensuring that the document retains its integrity and connection to its original state, even after being handled by systems that lack the capability to process advanced formats.

The concept of a “boomerang” captures the cyclical nature of document transmission and reception. When a document is sent out, whether for review, approval, or processing, it often returns to the sender with modifications, annotations, or approvals. The ability to identify and reconcile the returned document with its original version is essential to maintaining a single source of truth. This process involves tracking the document's journey, recording its interactions, and ensuring that any changes made during its transit are accurately reflected in its updated state. The concept of a document boomerang illustrates how this is a closed-loop system, where the document's lifecycle is managed seamlessly, regardless of the number of times it is transmitted and received. By implementing mechanisms to track and verify the document's identity and changes, organizations can prevent fragmentation and ensure that the document remains consistent and reliable throughout its lifecycle.

The process of ensuring continuity and preventing duplication when an electronic document is sent to an agency that only handles PDFs can be performed through the implementation of robust mechanisms that embed unique identifiers or codes within the document prior to transmission. These identifiers serve as a digital fingerprint, enabling the system to verify the document's identity upon its return. Below are several examples of how this process can be executed:
Embedding QR Codes: Before the document is sent, a unique QR code can be embedded on each page of the document. This QR code contains metadata such as the document's unique identifier, version number, and timestamp. When the document is returned, the system scans the QR code to match it with the original record in the system of record. This ensures that the returned document is recognized as the same one that was originally sent, even if modifications or annotations have been made.
Invisible Watermarks: The document can be embedded with invisible digital watermarks that are machine-readable but not visible to the human eye. These watermarks can include information such as the document's origin, creation date, and unique identifier. Upon return, the system reads the watermark to verify the document's authenticity and match it to the original record.
Hash-Based Verification: A cryptographic hash of the document's content can be generated before transmission. This hash acts as a digital fingerprint of the document. When the document is returned, the system recalculates the hash and compares it to the original hash stored in the system of record. If the hashes match, the document is verified as the same one that was sent.
Document Serialization: Each document can be serialized with a unique identifier that is printed or embedded within the document. For example, a serialized number can be included in the header or footer of each page. When the document is returned, the system checks the serialized number against its records to confirm the document's identity.
Barcode Integration: Similar to QR codes, barcodes can be used to encode the document's unique identifier and other metadata. These barcodes can be scanned upon the document's return to verify its identity and ensure it matches the original record.
Metadata Tagging: The document can be tagged with metadata that includes its unique identifier, version history, and other relevant information. This metadata can be embedded in the document's file properties or as a separate layer within the document. Upon return, the system reads the metadata to confirm the document's identity and reconcile it with the original record.
AI-Based Content Matching: For documents that lack embedded identifiers, advanced AI algorithms can be used to analyze the content of the returned document and match it to the original. These algorithms can compare text, images, and layout to identify similarities and confirm the document's identity.
Distributed-Ledger-Based Tracking: The document's unique identifier and metadata can be recorded on a blockchain ledger. When the document is returned, the system checks the blockchain to verify its authenticity and ensure it matches the original record. This approach provides an additional layer of security and traceability.
Version Control Systems: The system can maintain a version control repository where each document is stored with its unique identifier and version history. When the document is returned, the system compares the returned version with the repository to ensure continuity and prevent duplication.
Dynamic Entry Pages: For legacy systems that only handle PDFs, the document can include a dynamic entry page that contains a link or code directing the recipient to the original intelligent document. Upon return, the system uses the entry page's embedded information to reconcile the returned document with the original.

By implementing these mechanisms, organizations can ensure that documents retain their integrity and connection to their original state, even after being processed by systems that lack the capability to handle advanced formats. These approaches not only prevent duplication but also streamline workflows and enhance document traceability.

The process of detecting and managing document transmission can be implemented through various technical approaches, each tailored to the specific communication channel being used. One approach involves modifying the POP3 server to intercept and process incoming and outgoing emails, enabling the system to identify and manage electronic documents during transmission. Alternatively, integration with the email client itself, such as Outlook or G Suite, allows the system to operate directly within the user's interface, providing a more seamless experience. Customer portals offer another avenue for document transmission, where users can upload or download documents directly through a secure web interface. Fax machines, though less common, remain a viable method of transmission in certain contexts, and the system can be designed to handle documents sent and received via fax. Each of these methods ensures that the system can detect, process, and manage electronic documents effectively, regardless of the communication channel, while maintaining the integrity and traceability of the document throughout its lifecycle.

[]

A smart document is designed to ensure the integrity, authenticity, and traceability of its content and associated audit trail through the use of immutability, a global marker, and embedded intelligence. This innovative structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable associated between the global marker and the content and audit trail—creates a robust framework that will revolutionize document management and control.

The immutability of the content, the audit trail, the global marker and of the link between the marker and the data (i.e., the content, the audit trail, and any other metadata) and the global marker, can have one or more of a variety of characteristics:
Unchangeable: Immutable refers to something that cannot be altered, modified, or edited once it has been created or finalized.
Permanent: Immutable signifies a state of permanence, where the object or data remains fixed and consistent over time.
Irreversible: Immutable describes a condition where changes are impossible, and any attempt to alter the object or data is invalid or rejected.
Fixed: Immutable means that the structure, content, or state of an object is locked and cannot be adjusted or updated.
Tamper-Proof: Immutable implies that the object or data is resistant to tampering, ensuring its integrity and authenticity.
Finalized: Immutable refers to an object or data that has reached its final form and cannot be reverted or reshaped.
Unmodifiable: Immutable describes a characteristic where the object or data is impervious to modification, whether intentional or accidental.
Consistent: Immutable ensures that the object or data remains consistent and reliable, unaffected by external influences or changes.
Secure: Immutable denotes a state of security where the object or data is safeguarded against unauthorized alterations or corruption.
Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.
Traceability: The immutable audit trail provides a complete and verifiable history of all interactions with the document.
Authenticity: The permanent global marker guarantees that the document can always be uniquely identified and retrieved, eliminating ambiguity.
Compliance: This structure simplifies regulatory compliance by providing a reliable and tamper-proof record of the document and its history.
Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a transformative solution for document management, offering unparalleled integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.)

In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.
Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.
Negotiation of Communication Protocols: Smart documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.
Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.
Machine Learning and Predictive Capabilities: Smart documents can leverage machine learning algorithms to analyze their audit trail, content, and metadata to predict user needs or suggest actions. For instance, a smart document can identify patterns in user interactions and recommend next steps, such as suggesting additional documents that may be relevant to the current task or flagging anomalies in the audit trail for review.

### How Intelligence Is Embedded

The intelligence of smart documents is embedded through the integration of one or more components:
Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.
Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.
Machine-Readable Content: Unlike traditional documents, which are primarily human-readable, smart documents store their content in a machine-readable format. This allows the embedded intelligence to analyze the content, extract specific information, and perform operations based on the content's structure and meaning.
APIs for Interaction: Smart documents expose APIs (Application Programming Interfaces) that allow external systems to interact with them. These APIs enable the document to receive requests, process them, and return responses in a structured format, such as JSON or XML. The APIs also facilitate integration with other applications and systems, making the document highly interoperable.
Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.
Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.
Dynamic Rendering: When accessed on a mobile device, a smart document can automatically adjust its layout to optimize readability and usability, while providing additional features like touch-based navigation.
Workflow Management: A smart document associated with a workflow can track its progress and notify stakeholders of pending actions, such as signatures or approvals.
Content Extraction: A smart document can respond to a query by extracting specific information from its content, such as the total amount in an invoice or the number of items listed in a receipt.
Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a transformative innovation in document management.

The combination of immutability and embedded intelligence in smart documents creates a transformative paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that revolutionizes document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.
Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.
Dynamic Traceability: The immutable audit trail provides a complete history of interactions with the document, while embedded intelligence allows the document to analyze and interpret this history. This dynamic traceability enables stakeholders to understand not only what happened to the document but also why and how.
Personalized Compliance: Immutability simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.
Interoperability and Adaptability: The permanent global marker ensures seamless integration with external systems, while embedded intelligence enables the document to negotiate communication protocols and adapt its responses to different platforms. This combination ensures that the document can function effectively in diverse environments.
Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-World Applications

The synergy of immutability and embedded intelligence has transformative implications across industries:
Legal and Compliance: Smart contracts can ensure the integrity of agreements while dynamically adapting to regulatory changes.
Finance: Immutable audit trails and intelligent analysis can enhance fraud detection and streamline reporting.
Healthcare: Patient records can remain secure and authentic while providing personalized access to authorized stakeholders.
Supply Chain: Immutable tracking and intelligent analysis can optimize logistics and ensure product authenticity.

In summary, the combination of immutability and embedded intelligence in smart documents creates a revolutionary framework for document management. By ensuring integrity, authenticity, and traceability while enabling dynamic interactions and personalized experiences, this synergy addresses longstanding challenges and unlocks new possibilities for innovation and efficiency.

### Alternative Terminology

The term “smart document” or “smart electronic document” can also be referred to as a self-determinative document, a self-tracking document, a self-assimilating document, a document with executable code, a document with embedded code, and/or in a variety of other ways depending on the context and on the features of the smart document. In any example, a smart electronic includes three elements, at minimum—data (e.g., content, audit trail, other metadata, etc.), executable code (e.g., an API), and a globally unique marker.

In some examples, the system operates by identifying attempts to transmit electronic documents across various communication channels, such as email or fax. When an electronic document is attached to an email message, the system detects the attachment and initiates a process to analyze and manage the document. Similarly, when a document is transmitted via a fax machine, the system intercepts the transmission and processes the incoming data. Regardless of the transmission method, the system is capable of handling different document formats, including PDFs and bitmap files. For a PDF document, the system recognizes the structured format and extracts relevant metadata and content for further processing.

In the case of a bitmap file, which is typically an image-based representation, the system employs optical character recognition (OCR) or other image analysis techniques to interpret the content and convert it into a machine-readable format. This ensures that the transmitted document, whether a PDF or a bitmap, is seamlessly integrated into the system for tracking, management, and further actions, such as deduplication or conversion into a factified document.

The described methods and systems provide a technical solution to the persistent technical problem of maintaining control, security, and adaptability of electronic documents once they are transmitted across computer networks. Traditional systems rely on static security measures, such as encryption or passwords, which fail to provide dynamic control or real-time adaptability once a document leaves its original digital perimeter. This method addresses these limitations by embedding intelligence into electronic documents during transmission, transforming them into self-determinative entities capable of autonomous lifecycle management. By leveraging computer hardware and networking infrastructure, the system ensures that documents retain centralized control, even as they are distributed across diverse devices and platforms.

From a hardware perspective, the methods and systems utilize physical processors to execute detection, determination, and provisioning instructions, enabling efficient processing of document transmission attempts. For example, the system can monitor file operations, analyze metadata, and enforce policies in real-time, ensuring that the computational workload is distributed effectively across devices. This reduces the risk of bottlenecks in document management workflows and optimizes the use of hardware resources, such as CPUs and memory, to handle complex operations like encryption, metadata analysis, and dynamic content rendering.

In terms of networking, the methods and systems enhance the security and efficiency of data transmission by replacing static files with links to self-determinative documents stored in secure repositories. This approach minimizes the duplication of files across networks, reducing bandwidth consumption and storage requirements. Instead of transmitting entire files, the system transmits lightweight links, which direct recipients to centralized locations where the documents are securely managed. This reduces the strain on network infrastructure, particularly in environments with high volumes of document sharing, such as enterprise systems or cloud-based collaboration platforms.

Additionally, the methods and systems improve the reliability of document access across distributed systems. By embedding intelligence into documents, the system ensures that access controls, permissions, and contextual adaptations are enforced consistently, regardless of the recipient's device or location. This eliminates compatibility issues that often arise when documents are accessed on different hardware or operating systems. Furthermore, the system's ability to track interactions and enforce policies in real-time enhances the integrity of document management processes, providing robust protection against unauthorized access or data leakage.

Overall, the methods and systems disclosed herein transform electronic documents into active participants in digital ecosystems, leveraging computer hardware and networking infrastructure to address the technical challenges of document security, control, and adaptability. By reducing resource consumption, enhancing scalability, and ensuring consistent enforcement of policies, the system provides a comprehensive solution for modern document management in interconnected digital environments.

In conclusion, the detailed description provided herein illustrates the exemplary systems, methods, and processes for transforming electronic documents into self-determinative entities capable of autonomous lifecycle management, dynamic interaction, and secure control. By embedding intelligence into documents during transmission, the embodiments disclosed herein address longstanding technical challenges related to document security, adaptability, and centralized control in modern digital environments. Leveraging advanced computing hardware, networking infrastructure, and machine learning capabilities, the described embodiments ensure that electronic documents retain their integrity, enforce access controls, and adapt to contextual requirements across diverse platforms and devices. While specific examples and configurations have been presented, the scope of this disclosure is not limited to these embodiments, as numerous modifications, alternatives, and equivalents are possible without departing from the spirit and scope of the disclosure. The described technology represents a fundamental shift in how electronic documents are managed, offering robust solutions to enhance security, compliance, and efficiency in dynamic workflows.
Clause 1. A method comprising: detecting an attempt to transmit an electronic document; determining that a policy indicates that the electronic document is to be at least partially converted into a self-determinative document; and responding to the determination by provisioning, to the self-determinative document, embedded intelligence that enables self-determination of the document.
Clause 2. The method of clause 1, wherein: the attempt to transmit the electronic document comprises an attempt to email the document; the method further comprises replacing the electronic document with a link to the self-determinative document; and after replacing the electronic document with the link, allowing the email to be sent to a destination.
Clause 3. The method of clause 1, wherein the attempt to transmit the electronic document comprises an attempt to upload the document to cloud storage.
Clause 4. The method of clause 1, wherein responding to the determination by provisioning the embedded intelligence comprises: determining that a different instance of the electronic document has already been converted to the self-determinative document; and replacing the electronic document being transmitted with a link to the self-determinative document.
Clause 5. The method of clause 1, wherein responding to the determination by provisioning the embedded intelligence comprises: determining that no instance of the electronic document has already been converted to the self-determinative document; creating the self-determinative document by associating the embedded intelligence with content of the document; and replacing the electronic document being transmitted with a link to the self-determinative document.
Clause 6. The method of clause 1, further comprising: analyzing, by a machine-learning model trained to interact with self-determinative documents, the self-determinative document; and providing, by the machine-learning model and in response to the analysis, a recommendation to an owner of the document.
Clause 7. A system comprising: at least one physical processor; physical memory comprising computer-executable instructions that, when executed by the physical processor, cause the physical processor to: detect an attempt to transmit an electronic document; determine that a policy indicates that the electronic document is to be at least partially converted into a self-determinative document; and respond to the determination by provisioning, to the self-determinative document, embedded intelligence that enables self-determination of the document.
Clause 8. The system of clause 7, wherein: the attempt to transmit the electronic document comprises an attempt to email the document; the computer-executable instructions, when executed by the physical processor, further cause the physical processor to replace the electronic document with a link to the self-determinative document, after replacing the electronic document with the link, allow the email to be sent to a destination.
Clause 9. The system of clause 7, wherein the attempt to transmit the electronic document comprises an attempt to upload the document to cloud storage.
Clause 10. The system of clause 7, wherein the computer-executable instructions cause the processor to respond to the determination by provisioning the embedded intelligence by: determining that a different instance of the electronic document has already been converted to the self-determinative document; and replacing the electronic document being transmitted with a link to the self-determinative document.
Clause 11. The system of clause 7, wherein the computer-executable instructions cause the processor to respond to the determination by provisioning the embedded intelligence by: determining that no instance of the electronic document has already been converted to the self-determinative document; creating the self-determinative document by associating the embedded intelligence with content of the document; and replacing the electronic document being transmitted with a link to the self-determinative document.
Clause 12. The system of clause 7, wherein the computer-executable instructions, when executed by the physical processor, further cause the physical processor to analyze, by a machine-learning model trained to interact with self-determinative documents, the self-determinative document; and provide, by the machine-learning model and in response to the analysis, a recommendation to an owner of the document.
Clause 13. A non-transitory computer-readable medium comprising computer-executable instructions that, when executed by at least one of one or more processors of a computing device, cause the computing device to: detect an attempt to transmit an electronic document; determine that a policy indicates that the electronic document is to be at least partially converted into a self-determinative document; and respond to the determination by provisioning, to the self-determinative document, embedded intelligence that enables self-determination of the document.
Clause 14. The non-transitory computer-readable medium of clause 13, wherein: the attempt to transmit the electronic document comprises an attempt to email the document; the computer-executable instructions, when executed by the physical processor, further cause the physical processor to replace the electronic document with a link to the self-determinative document, after replacing the electronic document with the link, allow the email to be sent to a destination.
Clause 15. The non-transitory computer-readable medium of clause 13, wherein the attempt to transmit the electronic document comprises an attempt to upload the document to cloud storage.
Clause 16. The non-transitory computer-readable medium of clause 13, wherein the computer-executable instructions cause the processor to respond to the determination by provisioning the embedded intelligence by: determining that a different instance of the electronic document has already been converted to the self-determinative document; and replacing the electronic document being transmitted with a link to the self-determinative document.
Clause 17. The non-transitory computer-readable medium of clause 13, wherein the computer-executable instructions cause the processor to respond to the determination by provisioning the embedded intelligence by: determining that no instance of the electronic document has already been converted to the self-determinative document; creating the self-determinative document by associating the embedded intelligence with content of the document; and replacing the electronic document being transmitted with a link to the self-determinative document.
Clause 18. The non-transitory computer-readable medium of clause 13, wherein the computer-executable instructions, when executed by the physical processor, further cause the physical processor to analyze, by a machine-learning model trained to interact with self-determinative documents, the self-determinative document; and provide, by the machine-learning model and in response to the analysis, a recommendation to an owner of the document.

The features and clauses discussed herein may provide one or more of the advantages and/or solutions described, such as enhancing security, improving operational efficiency, or enabling dynamic access control. Additionally, these features and clauses may offer further or alternative benefits or address further or alternative challenges beyond those explicitly mentioned. The disclosed features and clauses are not limited to the specific advantages or solutions described and may be implemented in various ways to achieve additional or alternative benefits and/or solutions.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
detecting an attempt to transmit an electronic document;
determining that a policy indicates that the electronic document is to be at least partially converted into a self-determinative document; and
responding to the determination by provisioning, to the self-determinative document, embedded intelligence that enables self-determination of the document.

2. The method of claim 1, wherein:
the attempt to transmit the electronic document comprises an attempt to email the document;
the method further comprises replacing the electronic document with a link to the self-determinative document; and
after replacing the electronic document with the link, allowing the email to be sent to a destination.

3. The method of claim 1, wherein the attempt to transmit the electronic document comprises an attempt to upload the document to cloud storage.

4. The method of claim 1, wherein responding to the determination by provisioning the embedded intelligence comprises:
determining that a different instance of the electronic document has already been converted to the self-determinative document; and
replacing the electronic document being transmitted with a link to the self-determinative document.

5. The method of claim 1, wherein responding to the determination by provisioning the embedded intelligence comprises:
determining that no instance of the electronic document has already been converted to the self-determinative document;
creating the self-determinative document by associating the embedded intelligence with content of the document; and
replacing the electronic document being transmitted with a link to the self-determinative document.

6. The method of claim 1, further comprising:
analyzing, by a machine-learning model trained to interact with self-determinative documents, the self-determinative document; and
providing, by the machine-learning model and in response to the analysis, a recommendation to an owner of the document.

7. The method of claim 1, wherein the self-determinative document is configured to interact with external systems, including artificial intelligence agents, using specialized communication protocols.

8. The method of claim 7, wherein the specialized communication protocols comprise Machine Communication Protocol (MCP).

9. The method of claim 1, wherein the self-determinative document esposes an application programming interface that allows external systems, including artificial intelligence agents, to query, analyze, or interact with the self-determinative document in a structured manner.

10. The method of claim 1, wherein the self-determinative document integrates with artificial intelligence platforms and acts as an active participant in a workflow.

11. The method of claim 1, wherein the self-determinative document processes requests from external systems, including artificial intelligence agents, using embedded intelligence to provide responses tailored to a context of the requests.

12. The method of claim 1, wherein the self-determinative document enforces role-based access control on users or external systems, including artificial intelligence agents.

13. The method of claim 1, wherein the self-determinative document autonomously evaluates permissions for specific sections of the self-determinative document for users or external systems, including artificial intelligence agents.

14. The method of claim 1, wherein the self-determinative document maintains an immutable audit trail of interactions, including identity, time, and nature of interactions by users or external systems, including artificial intelligence agents, the immutable audit trail being linked to a permanent global marker.

15. The method of claim 1, further comprising analyzing engagement with the self-determinative document by a machine-learning model trained to interact with self-determinative documents and, in response to the analyzing, providing a recommendation to an owner of the self-determinative document.

16. The method of claim 1, wherein detecting the attempt to transmit the electronic document comprises detecting an attempt to print the electronic document.

17. The method of claim 1, wherein responding to the determination comprises replacing printed output of the electronic document with an entry page that includes a link or a QR code directing a recipient to a self-determinative version of the electronic document.

18. The method of claim 17, wherein the entry page comprises a representation compatible with legacy workflows and prompts a recipient to access the self-determinative version of the electronic document by clicking the link or scanning the QR code.

19. The method of claim 17, wherein the link or the QR code directs a recipient to a secure repository where the self-determinative version of the electronic document is stored.

20. The method of claim 17, wherein the entry page comprises a static cover page including a message indicating that the document is a self-determinative document and instructing the recipient to access its full features by clicking the embedded link or scanning the QR code.

21. The method of claim 1, wherein responding to the determination comprises printing one or more pages of the electronic document with a unique QR code embedded on each page.

22. The method of claim 21, wherein the unique QR code is visible and machine-readable.

23. The method of claim 1, wherein responding to the determination comprises printing a barcode that encodes a unique identifier associated with the electronic document.

24. The method of claim 1, wherein responding to the determination comprises printing invisible, machine-readable watermarks with the content of the electronic document.

25. The method of claim 1, further comprising recording, in an immutable audit trail linked to a permanent global marker, an event corresponding to the printing, the event including an identity associated with the printing, a time of the printing, and a nature of the interaction.

26. A system comprising:
at least one physical processor;
physical memory comprising computer-executable instructions that, when executed by the physical processor, cause the physical processor to:
detect an attempt to transmit an electronic document;
determine that a policy indicates that the electronic document is to be at least partially converted into a self-determinative document; and
respond to the determination by provisioning, to the self-determinative document, embedded intelligence that enables self-determination of the document.

27. The system of claim 26, wherein:
the attempt to transmit the electronic document comprises an attempt to email the document;
the computer-executable instructions, when executed by the physical processor, further cause the physical processor to replace the electronic document with a link to the self-determinative document, after replacing the electronic document with the link, allow the email to be sent to a destination.

28. The system of claim 26, wherein the attempt to transmit the electronic document comprises an attempt to upload the document to cloud storage.

29. The system of claim 26, wherein the computer-executable instructions cause the processor to respond to the determination by provisioning the embedded intelligence by:
determining that a different instance of the electronic document has already been converted to the self-determinative document; and
replacing the electronic document being transmitted with a link to the self-determinative document.

30. The system of claim 26, wherein the computer-executable instructions cause the processor to respond to the determination by provisioning the embedded intelligence by:
determining that no instance of the electronic document has already been converted to the self-determinative document;
creating the self-determinative document by associating the embedded intelligence with content of the document; and
replacing the electronic document being transmitted with a link to the self-determinative document.

31. The system of claim 26, wherein the computer-executable instructions, when executed by the physical processor, further cause the physical processor to
analyze, by a machine-learning model trained to interact with self-determinative documents, the self-determinative document; and
provide, by the machine-learning model and in response to the analysis, a recommendation to an owner of the document.

32. A non-transitory computer-readable medium comprising computer-executable instructions that, when executed by at least one of one or more processors of a computing device, cause the computing device to:
detect an attempt to transmit an electronic document;
determine that a policy indicates that the electronic document is to be at least partially converted into a self-determinative document; and
respond to the determination by provisioning, to the self-determinative document, embedded intelligence that enables self-determination of the document.

33. The non-transitory computer-readable medium of claim 32, wherein:
the attempt to transmit the electronic document comprises an attempt to email the document;
the computer-executable instructions, when executed by the physical processor, further cause the physical processor to replace the electronic document with a link to the self-determinative document, after replacing the electronic document with the link, allow the email to be sent to a destination.

34. The non-transitory computer-readable medium of claim 32, wherein the attempt to transmit the electronic document comprises an attempt to upload the document to cloud storage.

35. The non-transitory computer-readable medium of claim 32, wherein the computer-executable instructions cause the processor to respond to the determination by provisioning the embedded intelligence by:
determining that a different instance of the electronic document has already been converted to the self-determinative document; and
replacing the electronic document being transmitted with a link to the self-determinative document.

36. The non-transitory computer-readable medium of claim 32, wherein the computer-executable instructions cause the processor to respond to the determination by provisioning the embedded intelligence by:
determining that no instance of the electronic document has already been converted to the self-determinative document;
creating the self-determinative document by associating the embedded intelligence with content of the document; and
replacing the electronic document being transmitted with a link to the self-determinative document.

37. The non-transitory computer-readable medium of claim 32, wherein the computer-executable instructions, when executed by the physical processor, further cause the physical processor to
analyze, by a machine-learning model trained to interact with self-determinative documents, the self-determinative document; and
provide, by the machine-learning model and in response to the analysis, a recommendation to an owner of the document.

38. The non-transitory computer-readable medium of claim 32, wherein detecting the attempt to transmit the electronic document comprises detecting an attachment to an electronic mail message.

39. The non-transitory computer-readable medium of claim 32, wherein detecting the attempt to transmit the electronic document comprises detecting a transmission from a fax machine.
